(19) United States
(12) Patent Application Publication
(10) Pub. No.: US 2008/0196056 A1
(43) Pub. Date: Aug. 14, 2008

(54) METHOD OF AUGMENTING LOCAL PROGRAMMING CONTENT

(76) Inventors: Ronald W. Bassett, Pflugerville, TX (US); Thomas A. Bellwood, Austin, TX (US); Robert B. Chumbley, Austin, TX (US); Matt F. Rutkowski, Pflugerville, TX (US)

Correspondence Address: IBM CORPORATION (SS), C/O STREETS & STEELE, 13831 NORTHWEST FREEWAY, SUITE 355, HOUSTON, TX, 77040, US

(21) Appl. No.: 11/673,622

(22) Filed: Feb. 12, 2007

(51) Int. Cl. H04N 7/16

(52) U.S. Cl. 725/25

(57) ABSTRACT

A method and business model are provided for augmenting programming content at a remote location, such as a hotel, with the programming content ordinarily provided under subscription to a home location, such as a user's home. A user agreement is formed between a user and a home service provider, delineating the content provided by the home service provider to the home location. A service provider agreement is formed between the home service provider and a remote service provider, delineating content to be broadcast from the home location to the remote location. Local content is selectively augmented by the home content and displayed on a viewing device at the remote location. The user may remotely access settings and functions of a home set top box while at the remote location.

### BACKGROUND OF THE INVENTION

1. Field of the Invention

The present invention relates to the broadcasting and display of multimedia content.

2. Description of the Related Art

Consumers invest a significant amount of money in home entertainment, including monthly fees for television programming subscriptions. For example, a large percentage of households in developed countries pay a monthly fee for at least basic cable television service, and additional fees for expanded services and programming content, such as digital cable access, sports packages, movie packages, and HDTV. Programming and services are often conveniently displayed and controlled with the use of a set top box (STB). The typical consumer is at a significant disadvantage while away from home, when the consumer is without access to any of the programming and services provided by subscription to the consumer's home. The traveling consumer also lacks the familiarity and convenience of selecting and managing programming content using the consumer's own STB.

Some currently-available products allow users to remotely access their home theater equipment and subscription programming content. For instance, an assortment of products is available from Sling Media, such as the Slingbox Tuner™, Slingbox AV™, and Slingbox PRO™. The Slingbox Tuner™, for example, allows users to access their basic cable programming on a PC or mobile device while away from home via the Internet. While popular, such presently available products have numerous limitations. First, these products require a broadband connection for transmitting programming content to a remote location. Broadband connections can be expensive, and are not universally available. Thus, a traveler cannot always use such a product from any hotel or destination around the world. Also, the bandwidth provided by a typical broadband connection, while ample for many applications, is still limited in comparison to the bandwidth available over broadcast channels such as cable or satellite. Therefore, the broadband connection can be completely unavailable or a bottleneck limiting the quality and quantity of a multimedia signal, such as a television signal, being transmitted through the broadband connection to the remote location. In many practical instances, these existing products also confine a user to viewing the content on (or at least require the use of) a computer, such as a laptop computer, whose display size and features are usually small in comparison to a full-size television at the user's home. Furthermore, existing products require hardware, which typically must be transported by a user while traveling.

Existing products have further disadvantages from the perspective of service providers and advertisers. A service provider suffers a financial risk by virtue of a consumer being able to transmit the programming content provided at the user's home to a remote location for free over the Internet. For instance, such products potentially allow content to be sent to a non-subscriber to enjoy the content without paying a fee. Unauthorized use of this technology may also potentially threaten copyright owners who have a financial interest in the programming content being redistributed. Likewise, local advertisers at a remote location may not achieve their full potential for advertising revenues where consumers can completely avoid local programming content and the accompanying advertisements.

An improved solution is therefore needed for allowing a user to enjoy subscription programming content and services while away from home. It would be desirable for such a solution to allow the user to enjoy the same level of bandwidth and features of subscription-based programming content that the user normally enjoys at home. It would also be desirable to potentially eliminate the need for transporting hardware while traveling. Such a solution would preferably also benefit local advertisers and local service providers.

### SUMMARY OF THE INVENTION

According to one embodiment, multimedia content provided to a home viewing location by a home service provider is selected. Multimedia content provided to a remote location by a remote service provider is also selected. The selected multimedia content provided by the home service provider is transmitted to the remote location along broadcast channels. The selected multimedia content provided by the home service provider is selectively combined with the selected multimedia content provided by the remote service provider. The combined multimedia content is selectively displayed.

### BRIEF DESCRIPTION OF THE DRAWINGS

FIG. 1 is a schematic diagram of a system for augmenting programming content at a remote viewing location with programming content at a home viewing location.

FIG. 2 is a schematic diagram illustrating one embodiment of augmenting programming content at a remote location with programming content ordinarily provided under subscription to a home viewing location to produce a combined content.

FIG. 3 is a schematic diagram of the system of FIG. 1, illustrating the accessing of the home set top box from the remote location.

FIG. 4 is a flowchart of one embodiment of a method according to the invention.

### DETAILED DESCRIPTION

The present invention provides methods and systems for augmenting programming content at a remote location, such as a hotel, with programming content that is normally available to the user, such as content provided under subscription to a user's home. The user may access programming content provided by the user's home service provider (HSP) while away from home, even while traveling outside the HSP's coverage area. In one embodiment, a user may use a remote viewing device provided at the remote location to remotely access content usually provided at the user's home through a home viewing device. In one variation of this embodiment, a user may use an optional remote set top box (remote STB) provided at the remote location to remotely access the content usually provided at the user's home through an optional home set top box (home STB). The user may log into an interface at the remote location, such as through the remote set top box provided at the remote location, and access the same programming content provided to the user by the HSP. Optionally, the user may remotely access the user's home STB to access the same or similar on-screen menus and options provided by the home STB. The HSP and a remote service provider (RSP) cooperate to provide these services to the user, typically in exchange for a fee from the user. The home viewing devices and remote viewing devices are not limited to televisions, nor to televisions connected to set top boxes. Other types of remote viewing devices and home viewing devices include, for example, cell phones, PDAs, and game consoles.

The invention spurs a new business model encouraging interaction between service providers. Financial incentives are available to the cooperating service providers, including increased user fees and enhanced advertising revenue. The user may be charged a fee for the ability to access subscription programming content while away from home. The fee may be shared by both the HSP and RSP according to a service provider agreement (SP Agreement). The agreement may be presented to the user at either the HSP or the RSP locations and the agreement between the HSP and the RSP can be dynamically created or updated/augmented based upon on-demand use of the services. The invention allows programming content provided by the HSP to be interspersed with programming content provided by the RSP. For example, an American traveling abroad may elect to watch an American football game broadcast by the HSP in lieu of a soccer game broadcast by the RSP. Advertisements ordinarily provided by the HSP during the American football game may be substituted with advertisements provided by the RSP that are more specific and relevant to the user's present travel location. For example, while watching the American football game, the user may be presented with advertisements for a restaurant near the user's hotel, in lieu of an advertisement for a pizza chain near the user's home. Such advertisements may be presented in the traveler's preferred language, as specified in a user agreement or in settings on the home STB. Advertising revenues may therefore be enhanced. The ability of a user to access familiar programming from an interface similar to the home STB encourages television viewing by travelers, while the selective substitution of advertising content pertaining to the remote location takes advantage of this increased viewing participation to enhance local advertising revenue. Other embodiments, features, and benefits are described with reference to the figures.

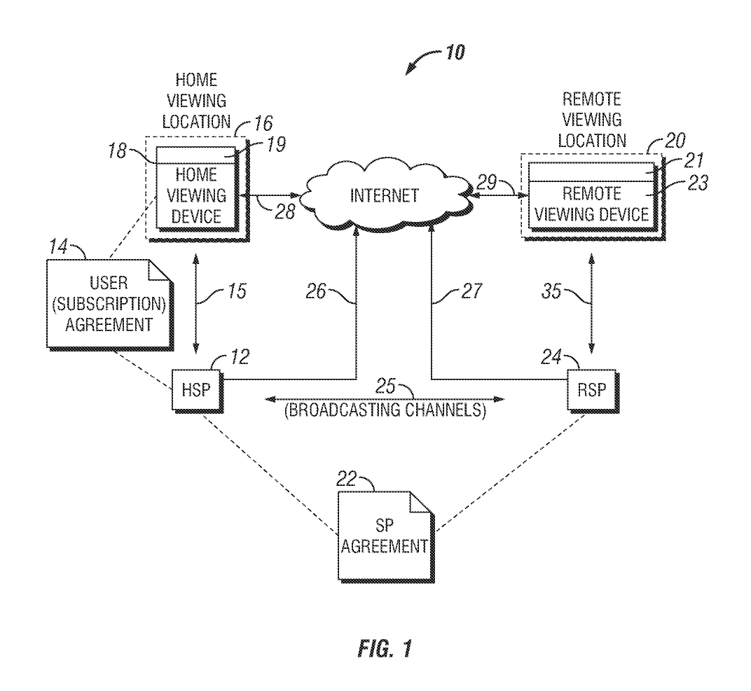

FIG. 1 is a schematic diagram of a system 10 for augmenting programming content at a remote viewing location (“remote location”) 20 with programming content available from a home viewing location (“home location”) 16. Programming content, generally referred to herein as “content,” includes multimedia containing video, audio, still images, or combinations thereof. The terms “remote” and “home” are defined with respect to one another. The home location 16 generally refers to a service region where the user has an agreement with a service provider to provide content, and is typically (but not necessarily) a home where the user lives. The remote location 20 is a location away from the home location 16. For example, if the user's house in Austin, Tex. is the home location 16, then a hotel in Argentina where the user is staying may be defined as the remote location 20 with respect to the home location 16. (It is not a requirement that the home location 16 and remote location 20 be in different countries.) A user has a programming subscription embodied in a user agreement 14 entered into between the user and a home service provider (“HSP”) 12 for providing content to the home location 16 in exchange for a user fee. The HSP 12 is typically a cable or satellite television provider. The content provided by the HSP 12 may be interchangeably referred to as “home content” and “HSP content.” The user agreement 14 specifies programming content and services provided to the user at the home location 16, such as basic channels, upgraded programming packages such as a sports package, a movie package, an HDTV package, and so forth.

The HSP 12 typically provides the content to the home location 16 along a communication pathway 15. The communication pathway 15 preferably involves “broadcast channels” such as CATV cable, fiber-optic lines, copper cables, a satellite transmission network, or other high-bandwidth channel suitable for broadcasting television programming content. The communication pathway 15 may be alternately referred to as a “broadcast communication pathway.” A home viewing device 18 such as a television or home theater system (or, in other embodiments, such as cell phone, PDA, or game console) is provided for viewing the content. An optional home STB 19 may convert the signals into the video and/or audio before feeding them to the home viewing device 18 at the home location 16. Alternatively, the home viewing device 18 may directly convert the signals, without the use of a home STB. The optional home STB 19 does not necessarily contain its own tuner. In other embodiments, the home STB 19 may be omitted, and signals from the communication channel 15 may instead be routed directly to a television, or to a component connected to the television, such as a DVD player, VCR, PDA, or game console.

The HSP 12 and a remote service provider (“RSP”) 24 cooperate to distribute content, such as under a service provider (“SP”) agreement 22. The RSP 24 is typically another cable or satellite television provider who services the remote location 20, providing content to the remote location 20 that may be interchangeably referred to as “remote content” or “RSP content.” The RSP ordinarily provides the RSP content to the remote location 20 along communication pathway 35 even in the absence of cooperation with the HSP 12. Under the SP agreement 22, the HSP 12 agrees to not only provide RSP content to the remote location 20, but to also selectively provide HSP content to the remote location 20, as delineated in the user agreement 14. The HSP content may be routed from the HSP 12 to the remote location 20 along communication pathways 25, 35, which are preferably part of a network of broadcast channels that includes communication pathway 15. As the content is routed to the RSP 24, the RSP 24 may optionally cache and then selectively rebroadcast that content to the remote location 20. The content broadcast to the remote location 20 may then be displayed on a remote viewing device 23, such as a laptop computer, personal computer (PC), television (e.g. CRT-type, flat-panel, rear-projection or other variety), automotive navigation system, PDA, smartphone, or game console. The broadcast channels desirably allow the content to be broadcast and viewed at the remote location 20 at substantially the same bandwidth that it was broadcast to the home location 16.

Optionally, the SP agreement 12 may also be controlling while the user is at the home location 16. For example, augmented content under the SP agreement 12 may be provided to the user when the user is at the home view location 16. This feature may be particularly useful to a user frequently traveling between locations. For example, an engineer who frequently travels from her home in Texas to a field (remote) location in Louisiana may want to receive content from a Texas provider while in Louisiana, and receive content from a Louisiana provider while in Texas. Thus, the engineer may have a subscription agreement with the Texas provider, another subscription agreement with the Louisiana provider, and an SP agreement between the Texas and Louisiana providers may be controlling while the engineer is in either location.

The HSP 12, RSP 24, home STB 19, and remote STB 21 are also optionally networked via the Internet, as illustrated by optional communication pathways 26, 27, 28, and 29. These “Internet communication pathways” 26-29 provide electronic communication between various components of the system 10. The Internet communication pathways 26-29 generally do not provide as much bandwidth as the broadcast communication channels 15, 25, and 35, and are not optimally configured for or dedicated to broadcasting television programming, so content is not typically transmitted on the Internet communication pathways 26-29 according to the invention. However, the Internet communication pathways 26-29 are optionally used to control at least some aspects of the broadcasting of content from the HSP 12 to the remote location 20. If Internet bandwidth in the future permits sufficient capability, then it could also be used as an alternative channel for broadcast/transmission of content. For example, a user at the remote location 20 may use a remote STB 21 to access the home STB 19 over the Internet communication pathways 28, 29 to select pre-recorded (e.g. DVR) content, menus such as channel guides, channel settings like channel numbers and channel names, and so forth. The RSP 24 may access details of the user agreement 12 over the Internet communication pathways 26, 27. For example, the RSP 24 may determine a user's authorization to use the system 10 by verifying subscription information from the HSP 12. The RSP 24 may electronically communicate with the home STB 19, along Internet communication pathways 27, 28. Likewise, the HSP 12 may communicate directly with the remote STB 21 or remote viewing device 23, generally along Internet communication pathways 26, 29.

The RSP 24 may timeshift the HSP content, such as to account for any differences in time zone between the home location 16 and the remote location 20. For example, if the home location 16 and remote location 20 are in different time zones, the RSP 24 may receive the content as it is normally broadcast from the home location 16, cache the content and queue it for a period of time, and then rebroadcast the content to the remote location 20. Timeshifting may be orchestrated such that the remote location 20 receives the content at a clock time of the remote location 20 that is substantially equal to a clock time at which the broadcast was initially received in the time zone of the home location 16.

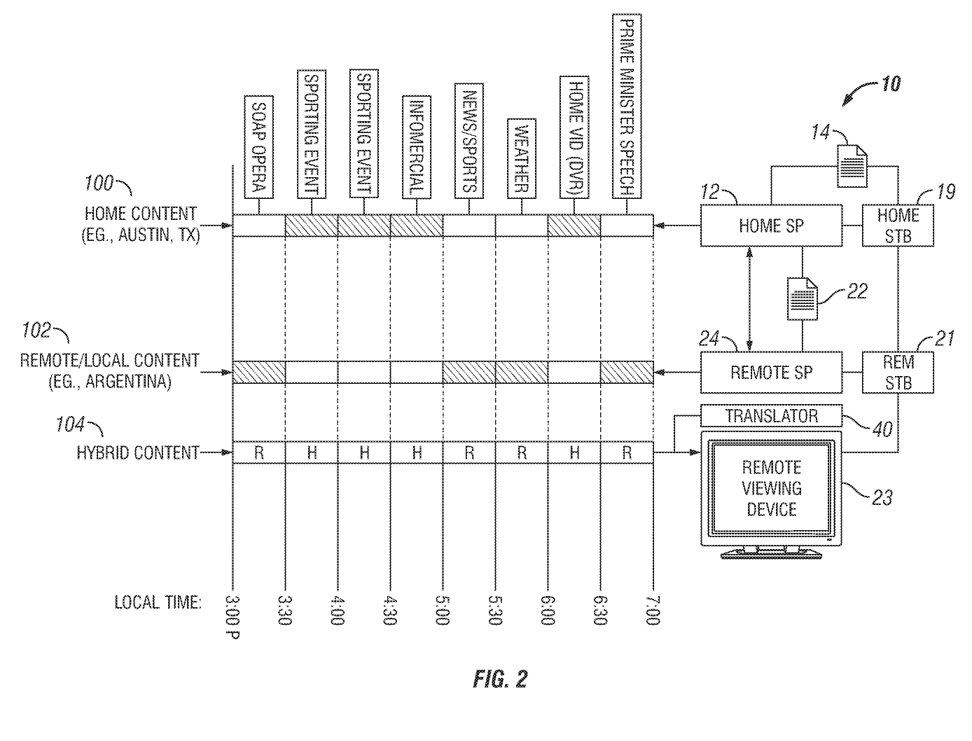

FIG. 2 is a schematic diagram illustrating one embodiment of augmenting programming content at a remote location with programming content ordinarily provided under subscription to a home viewing location to produce combined (“hybrid”) content 104. The HSP 12 provides selected “HSP content” 100 as delineated in the user agreement 14. The HSP content 100 typically includes programming content available on multiple television channels, each broadcasting different content of a variety of subject matter throughout the day. The HSP content 100 broadcast on each channel is typically scheduled into time slots. The HSP content 100 may also include prerecorded content stored on equipment at the home location. Likewise, the RSP content 102 typically includes many available channels, each broadcasting a variety of subject matter throughout the day. The RSP content 102 broadcast on each channel is also typically scheduled into time slots. Selected programming for time slots 3:00 PM to 7:00 PM are shown in FIG. 2, in half-hour increments, according to local time (i.e. the clock time at the remote location). The RSP content 102 may also include prerecorded content at the remote location. The HSP content 100 is selectively interspersed with the RSP content 102, and the resulting hybrid content 104 is displayed on the remote viewing device 23. For purpose of illustration, each block of programming content contributed by the HSP 12 is designated with an “H,” and each block of programming content contributed by the RSP 24 is designated with an “R.”

A sample timeline of hybrid content 104 is shown, wherein the home location is Austin, Tex. and the remote location is Argentina. For example, the first half-hour segment (3:00-3:30) is a local (Argentinean) soap-opera provided by the RSP 24. The next two half-hour segments (3:30-4:30) are a broadcast of a sporting event, such as an American football game, provided by the HSP 12. The user may elect to substitute the American football game for any local content provided during that hour. For example, the local content ordinarily provided by the RSP 24 from 3:30 to 4:30 might be a local sporting event, such as a soccer game. If, coincidentally, an American football game is simultaneously airing at the home location, the user may simply switch from displaying the soccer game provided by the RSP 24 to displaying the football game provided on a sports channel broadcast by the HSP 12. More commonly, the American and Argentinean sporting events will not be simultaneously broadcast. Thus, the user may view the American football game live as it is broadcast from the HSP 12, substituting for any local programming content (sports or otherwise) that happens to be broadcast at that moment. Alternatively, when an Argentinean sporting event airs live, the user may access a pre-recorded football game from the HSP content 100, such as a game the user has recorded on a DVR at the home location. Or, the RSP 24 may receive the broadcast of the football game from the HSP 12 and cache it in memory, queuing it for subsequent display on the remote viewing device 23 at the user's election.

Later, local news and weather provided by the RSP 24 from 5:00 to 5:30 may be displayed on the remote viewing device 23, because local content of that type is typically of greater immediate relevance to the user when at the remote location. Substitutions of HSP content 100 for local content 102 may occur manually, such as under control by the user, or automatically, such as under control by the HSP 12 or RSP 24. The resulting hybrid content 104 may be displayed substantially seamlessly, without any significant pauses or other demarcations between the display of local content 102 and the display of HSP content 100. The selection of advertising and programming content could be determined by direct transmission of remote region information over the Internet communication channels 26-29.

Content may be selectively tagged according to the subject matter (e.g. soap opera, sporting event, news, etc.), to automate the substitution of content with like subject matter. For example, a system could be configured to automatically display local content 102 provided by the RSP 24 when any of the content is tagged with the subject matter tags News, Weather, Daytime Programming, or Governmental Address, and to automatically default to displaying HSP content 100 unless otherwise specified by the user. If the facility exists within a given broadcast, it is also possible to substitute portions of a remote content for like portions within local content. For example, the sports portion of a local news broadcast from an HSP may be more relevant to the user at the remote location and thus be substituted for the sports portion of the broadcast at the remote location.

Content may be translated or otherwise provided in the preferred language of the user. A translator component 40 is optionally included with the system. The translator 40 may include hardware and/or software for real-time translation of an audio component of the local programming content 102. More commonly, however, the translator 40 represents a component of the business model provided by the invention, rather than a discrete piece of hardware or software. Because the invention gives local programming producers and advertisers the ability to capitalize on the viewership of travelers, it is possible for producers and advertisers to prepare advertisements and other content in a variety of languages commonly spoken by travelers to the remote location.

Decisions regarding the content to be viewed by the user at the remote location are preferably controlled by the user. The user may enter his instructions by manual entry into the remote STB or by allowing the content to be automatically selected in accordance with his or her predetermined user settings. Typically, a user would rely heavily on his user settings for consistent preferences, but make manual adjustments to the content on the basis of current mood, time available and other factors. The remote SP may obtain the user settings remotely, such as from memory of the user's home STB 19 or directly from the home SP 12. The user settings may also include the user's preferred or default language, which is typically the user's native language. The retrieved language settings may then be used to select local advertisements pre-prepared in the user's preferred language.

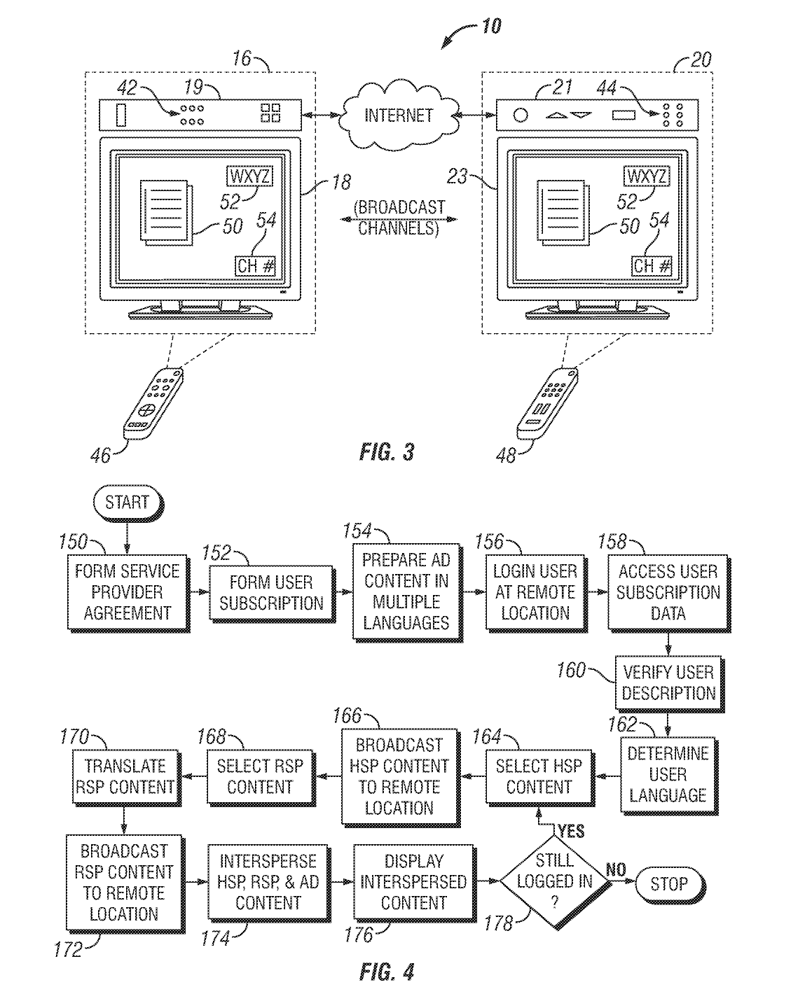

FIG. 3 is a schematic diagram of the system 10, illustrating the accessing of the home set top box 19 from the remote location 20. The home STB 19 and/or the home viewing device 18 may be accessed remotely from the remote location 20 via the Internet or broadcast channels. The home STB 19 has a set of buttons generally indicated at 42 for performing functions, such as toggling ON/OFF power to the home STB 19, navigating programming content, selecting channels and menus, and so forth. A wireless control device 46 (such as a so-called television “remote control”) is also preferably provided at the home location 10, for performing functions and controlling the home viewing device 18 and/or the home STB 19. Likewise, the remote STB 21 preferably has a set of buttons generally indicated at 44, and a wireless control device 48, for performing functions and controlling the remote viewing device 23 and/or the remote STB 21. The home STB 19 and remote STB 21 need not be identical, however, and may each perform different functions or perform some of the same functions differently. The invention allows a user to remotely access the functionality and interface of the home STB 19 using the buttons 44 and wireless control device 48 provided with the remote STB 21 at the remote location 20. For example, a user interface includes the option of displaying one or more onscreen menus 50, a station identifier 52, and a channel number 54. The identical onscreen menu 50, station identifier 52, and channel number 54 are displayable on the remote viewing device 23, in the same or similar way as they are shown displayed on the home viewing device 18. For example, the menu 50 may be a channel guide listing a multitude of channels and content descriptions, the station identifier 52 may be a text description of the channel currently displayed, and the channel number 54 may be a numerical description of the channel currently displayed. The ability for a user to access the same or similar menus, on-screen information and prompts, and other STB functionality provide the user with a familiar viewing experience when traveling away from home.

FIG. 4 is a flowchart of one embodiment of a method according to the invention. The flowchart generally outlines one approach to augmenting programming content and is not intended to limit the method to the particular steps and sequence of steps shown. In step 150, a service provider agreement is formed between at least two service providers, one of which is the HSP and another of which is the RSP. A particular service provider may be both an HSP with respect to local users at a location it services and an RSP with respect to travelers to that location. For example, a Texas cable television provider may form SP agreements with several other cable television providers around the country or around the world. The SP agreement would generally provide for the sharing of content between the service providers for viewing by customers of one or both of the service providers. Under a user agreement formed in step 152, the HSP provides programming content (“HSP content”) to its customers at their respective homes. In the above example, the Texas service provider is the HSP. When a customer of the HSP travels to a destination (the “remote location”), the service provider at the remote location is the RSP.

In step 154, advertising content may be prepared in advance in multiple languages. For example, a commercial for an Argentinean restaurant may be prepared in English, French, Italian, German, and Japanese, where those languages are commonly spoken by travelers to that remote location. Subsequently, these commercials may be selectively aired at the remote location according to the language preference of the user at the remote location.

According to step 156, the user may “log in” at the remote location. Logging in may be performed in a variety of ways. For example, when checking into a hotel at the remote location, a viewing device in the user's assigned room may be automatically configured with the user's preferences via information communicated from the home SP or home STB. Alternatively, the user may manually log in to a remote STB in the user's room. The user's subscription information, including the user's language preferences and other settings, may then be accessed in step 158. The user's subscription may be verified at login according to step 160, to ensure that the user is authorized to receive content from or through the HSP. An example of a setting that may be retrieved is the user's preferred language, according to step 162. It is also possible for all of this to be pre-configured for the traveler at the remote location, such as by a hotel that is hosting the RSP content.

In step 164, HSP content is selected, which may include television programming provided by the HSP and any prerecorded content at the user's home. The selection may be performed automatically by one or both of the HSP and RSP, manually by the user, or a combination thereof. In step 166, the selected HSP content may be broadcast to the remote location. The HSP content is not necessarily immediately displayed on a remote viewing device at the remote location, but may instead be cached by the RSP or on equipment in the user's room. The cached content may be queued for automatic retrieval at a later time, or stored indefinitely for the user to selectively access as desired. In step 168, RSP content is selected, which includes television programming provided by the RSP or prerecorded content stored on the remote viewing device (in the user's room at the remote location). In step 170, the RSP content may be selectively translated. The translation may be in real-time, using translation hardware or software known in the art. Alternatively, the advertising content that was prepared in step 154 may be selected according the user's preferred language. Like the HSP content, the RSP content is not necessarily displayed the moment it is selected, and may instead be displayed on a scheduled or as-needed basis. The selected RSP content may be broadcast or otherwise transmitted to the remote viewing device (in the user's room) in step 172. In step 174, the HSP content selected in step 164 is augmented with the RSP content selected in step 168. The combined content may be sequentially displayed on the remote viewing device in step 176 for as long as the user is logged in according to step 178.

It should be recognized that the invention may take the form of an embodiment containing hardware and/or software elements. Non-limiting examples of hardware include a home STB and a remote STB. A non-limiting example of software includes firmware residing on the home STB and remote STB. More generally, the invention can take the form of a computer program product accessible from a computer-readable medium providing program code for use by or in connection with a computer or any instruction execution system. For the purposes of this description, a computer-usable or computer readable medium can be any apparatus that can contain, store, communicate, propagate or transport the program for use by or in connection with the instruction execution system, apparatus or device, such as the home and remote STBs.

The medium can be an electronic, magnetic, optical, electromagnetic, infrared, or semiconductor system (or apparatus or device) or a propagation medium. Examples of a computer-readable medium include a semiconductor or solid state memory, a random access memory (RAM), a read-only memory (ROM), or flash memory.

A data processing system suitable for storing and/or executing program code typically includes at least one processor coupled directly or indirectly to memory elements. The memory elements can include local memory employed during actual execution of the program code, bulk storage, and cache memories that provide temporary storage of at least some program code in order to reduce the number of times code must be retrieved from bulk storage during execution.

Input/output (I/O) devices such as keyboards, displays, remote controls, or pointing devices can be coupled to the system, either directly or through intervening I/O controllers. Network adapters may also be used to allow the data processing system to couple to other data processing systems or remote printers or storage devices, such as through intervening private or public networks. Modems, cable modems, Ethernet cards, and wireless network adapters are examples of network adapters.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method, comprising:
selecting multimedia content provided to a home viewing location by a home service provider;
selecting multimedia content provided to a remote location by a remote service provider;
transmitting the selected multimedia content provided by the home service provider to the remote location along broadcast channels;
selectively combining the selected multimedia content provided by the home service provider with the selected multimedia content provided by the remote service provider; and
selectively displaying the combined multimedia content.

2. The method of claim 1, further comprising:
retrieving one or more user settings from one or both of a home set top box and the home service provider; and
selecting the multimedia content provided by the home service provider as a function of the user settings.

3. The method of claim 2, wherein the user settings include a preferred language.

4. The method of claim 2, wherein the user settings are transmitted over the Internet to the remote viewing location.

5. The method of claim 1, further comprising selectively translating the multimedia content provided by the remote service provider to a user's preferred language.

6. The method of claim 1, further comprising:
preparing local advertisements in a plurality of languages; and
displaying the local advertisements on the remote viewing device prepared in a language selected by the user or from the home user settings.

7. The method of claim 1, further comprising:
classifying multimedia content provided by the remote service provider by subject matter; and
substituting multimedia content classified by a given subject matter provided by the home service provider for the multimedia content provided by the remote service provider having the same subject matter classification.

8. The method of claim 7, further comprising:
electronically assigning a subject matter identifier to portions of the multimedia content provided by the home service provider;
electronically assigning a subject matter identifier to portions of the multimedia content provided by the remote service provider; and
selectively substituting the display of the portions of the multimedia content provided by the remote service provider with the portions of the multimedia content provided by the home service provider having equivalent subject matter identifiers.

9. The method of claim 1, further comprising selectively combining the selected multimedia content provided by the home service provider with the selected multimedia content provided by the remote service provider according to user preferences.

10. The method of claim 1, further comprising electronically transmitting pre-recorded content from a digital video storage device at the home viewing location to the remote viewing location.

11. The method of claim 1, further comprising time-shifting the display of the selected multimedia content provided by the remote service provider from a time zone of the home viewing location to a time zone of the remote viewing location.

12. The method of claim 1, further comprising transferring a fee between the home service provider and the remote service provider as a function one or both of bandwidth and advertising revenue.

13. The method of claim 1, further comprising:
storing location-specific multimedia content from selected geographical regions at the home viewing location;
identifying a geographical region of the remote viewing location; and
selectively displaying portions of the stored multimedia content from the same geographical region as the remote viewing location.

14. The method of claim 1, wherein the multimedia content provided to the home viewing location by the home service provider is defined according to a user agreement between the home service provider and a user.

15. The method of claim 1, wherein the multimedia content provided to the remote location by the remote service provider is defined according to a service provider agreement between the home service provider and the remote service provider.
